(19) United States
(12) Patent Application Publication
(10) Pub. No.: US 2021/0404387 A1
(43) Pub. Date: Dec. 30, 2021

(54) GAS TURBINE ENGINE AND AIRCRAFT WITH A GAS TURBINE ENGINE

(71) Applicant: Rolls-Royce Deutschland Ltd & Co KG, Blankenfelde-Mahlow (DE)

(72) Inventors: Gideon Daniel VENTER, Berlin (DE); Michael SCHACHT, Berlin (DE); Sebastian KOPP, Berlin (DE); Rüdiger MERZ, Berlin (DE)

(21) Appl. No.: 17/362,514

(22) Filed: Jun. 29, 2021

(30) Foreign Application Priority Data
Jun. 30, 2020 (DE) 102020117254.0

(51) Int. Cl. F02C 7/32; B64D 27/20; B64D 27/26

(52) U.S. Cl. CPC F02C 7/32; B64D 27/20; F05D 2220/323; F05D 2260/4031; B64D 27/26

(57) ABSTRACT

A gas turbine engine including an engine core and including a bypass channel of an aircraft is described. The bypass channel radially surrounds the engine core at least in part. At least one core shaft extending in the axial direction is provided, which shaft is operatively connected, by means of a drive train, to a core accessory gearbox arranged between the engine core and the bypass channel, and to an aircraft accessory gearbox. The aircraft accessory gearbox is arranged radially outside the bypass channel. The drive train extends substantially in the radial direction between the core shaft and the aircraft accessory gearbox. The drive train has an angle drive between a radial shaft and the core shaft. Furthermore, the drive train comprises another angle drive between the radial shaft and the core accessory gearbox and an additional angle drive between the radial shaft and the aircraft accessory gearbox.

This application claims priority to German Patent Application DE102020117254.0 filed Jun. 30, 2020, the entirety of which is incorporated by reference herein.

The present disclosure relates to a gas turbine engine comprising an engine core and comprising a bypass channel and to an aircraft having at least one gas turbine engine of this type.

US 2009/0123274 A1 discloses a gas turbine engine comprising what is known as a core accessory gearbox. The core accessory gearbox is provided between an engine core and a bypass channel. The gas turbine engine additionally comprises what is known as a aircraft gas turbine accessory gearbox which is installed radially outside the bypass channel. The core accessory gearbox is operatively connected to a high-speed spindle by means of a radial shaft and is driven by this spindle. In this case, the high-speed spindle has a high-speed compressor, a high-speed turbine and a high-speed shaft which connects the high-speed compressor to the high-speed turbine.

The aircraft accessory gearbox is connected to a low-speed spindle by means of another radial shaft and is driven by this spindle. The low-speed spindle has a low-speed compressor, a low-speed turbine and a low-speed shaft which connects the low-speed compressor to the low-speed turbine.

The core accessory gearbox drives a lubrication pump and other accessories. A fuel pump, an alternator and a hydraulic pump are drivingly coupled to the aircraft accessory gearbox.

It is proposed to select the accessories which are driven by the core accessory gearbox or by the aircraft accessory gearbox according to available installation space and the desired drive speed for the accessory in each case.

As a result of the two radial shafts, the gas turbine engine is characterized by an undesirably complex construction and, due to the large number of parts, has a high component weight and large external dimensions. All of this together causes high drag of the gas turbine engine, which increases fuel consumption of the gas turbine engine.

EP 0 659 234 B1 describes a gas turbine engine in which a radial shaft is connected to a low-pressure spindle by means of a reduction gearbox. The radial shaft extends from the low-pressure shaft as far as an inner gearbox which is arranged radially inside a bypass channel. The inner gearbox drives a hydraulic machine which can be operated as either a hydraulic motor or a hydraulic pump. Another radial shaft which is connected to an outer gearbox which is provided radially outside the bypass channel extends from the inner gearbox through the bypass channel.

The drive train between the low-pressure spindle and the outer gearbox has the disadvantage that the torque which is supplied to the outer gearbox is transmitted via the inner gearbox. For this reason, the inner gearbox is designed to be correspondingly powerful and thus leads to high production costs.

In addition, US 2014/0090386 A1 discloses a gas turbine engine comprising a core accessory gearbox and comprising an aircraft accessory gearbox. The two accessory gearboxes are driven either by core shafts of the gas turbine engine by means of separate shafts or are each driven by one of the core shafts by means of a common drive train. In the case of the latter connection to a single core shaft by means of a common drive train, in each case, the torque supplied to the core accessory gearbox or the aircraft accessory gearbox is conducted through the aircraft accessory gearbox or through the core accessory gearbox, but this is undesirable. The accessory gearbox which transfers the torque towards the other accessory gearbox in each case is to be designed to be correspondingly robust, and this requires costly design measures.

The object of the present disclosure is that of providing a gas turbine engine which has a simple design and is characterized by small external dimensions and low production costs as well as being fuel efficient, and providing an aircraft characterized by low fuel consumption.

This object is achieved by a gas turbine engine and by an aircraft having the features of Claims 1 and 14 respectively.

According to a first aspect, a gas turbine engine comprising an engine core and comprising a bypass channel is provided. The bypass channel radially surrounds the engine core at least in part. At least one core shaft, extending in the axial direction, of the gas turbine engine is provided. The core shaft is operatively connected to a core accessory gearbox and to an aircraft accessory gearbox by means of a drive train extending in the radial direction of the gas turbine engine. The core accessory gearbox is arranged between the engine core and the bypass channel. The aircraft accessory gearbox is provided radially outside the bypass channel.

In the present case, the arrangement of the aircraft accessory gearbox radially outside the bypass channel is understood to be a radial position of the aircraft accessory gearbox which is located outside the bypass channel and on the side of the bypass channel facing away from the engine core in the radial direction.

The core accessory gearbox is likewise arranged radially outside the bypass channel. However, the core accessory gearbox is positioned in a radial region of the gas turbine engine which is located radially within an inside diameter of the bypass channel.

The drive train extends substantially in the radial direction between the core shaft and the aircraft accessory gearbox. In addition, the drive train comprises an angle drive between a radial shaft and the core shaft, which angle drive can be for example in the form of a bevel gear set. Furthermore, the drive train comprises another angle drive between the radial shaft and the core accessory gearbox and an additional angle drive between the radial shaft and the aircraft accessory gearbox.

As a result of the common drive train of the core accessory gearbox and the aircraft accessory gearbox, both the core accessory gearbox and the aircraft accessory gearbox can receive torque from the core shaft in a manner which is advantageous in terms of installation space. According to the present disclosure, the gas turbine engine is also characterized by a simpler construction and a lower component weight by comparison with known gas turbine engines.

This is the case because both the core accessory gearbox and the aircraft accessory gearbox can each be designed to have less conductivity by comparison with known gas turbine engines. In the case of the gas turbine engine according to the present disclosure, the torque supplied to the core accessory gearbox and to the aircraft accessory gearbox is branched off from the radial shaft in each case by means of the assigned angle drive. The torque which is supplied to the core accessory gearbox or the aircraft accessory gearbox is not applied to either the core accessory gearbox or to the aircraft accessory gearbox.

The connection of the core accessory gearbox to the drive train or to the radial shaft provides an interface or a support point for the radial shaft which allows an expansion of the radial drive starting from the core shaft towards the aircraft accessory gearbox with a simple construction. The angle drive for removing torque from the radial shaft towards the core accessory gearbox can be dimensioned in such a way that bevel gears and bearings which are advantageous in terms of installation space can be used. The integration of the core accessory gearbox in the engine core, in which only limited installation space is available, is thus supported in a simple manner.

In the region of the core accessory gearbox, it is thus possible, in a constructionally simple manner, to support the radial shaft and to limit bending movements of the radial shaft between bearing positions. In turn, this makes it possible to design the diameter of the radial shaft substantially only according to the torque to be transmitted.

According to the present application in each case, it is possible for the angle drives to each be in the form of bevel gear sets in order to be able to introduce the torque from the radial shaft at the desired angle in each case into the core accessory gearbox or into the aircraft accessory gearbox. In this case, it can be provided that the bevel gear sets comprise bevel gears which are connected to the radial shaft for conjoint rotation. These bevel gears can be in engagement with additional bevel gears which are connected to input shafts of the accessory gearboxes. Alternatively, it can also be provided that the core shaft and/or the input shafts of the accessory gearboxes are designed to be integral with corresponding bevel gear sets which are in engagement with bevel gears which are operatively connected to the radial shaft.

If the radial shaft is formed as a single piece, the gas turbine engine according to the present disclosure can be installed in a simple manner.

Deviating from this, it can also be provided that the radial shaft has at least two radial shaft portions. The two radial shaft portions can be arranged coaxially with one another and one behind the other at least in some regions in the axial direction, and operatively connected to one another for conjoint rotation by means of a device such as a splined shaft connection or the like. Such a design of the radial shaft with multiple parts is simpler to produce in terms of manufacturing and is characterized by higher rigidity by comparison with a radial shaft formed as a single piece.

In the case of an embodiment of the gas turbine engine, which is advantageous in terms of installation space, according to the present disclosure, engine accessories are substantially operatively connected to the drive train by means of the core accessory gearbox, which engine accessories are provided to carry out functions of the gas turbine engine and which are arranged between the engine core and the bypass channel.

It is thus ensured in a simple manner that operative connections between what are known as engine accessories and regions of the gas turbine engine can be arranged on the engine core and can be designed with small dimensions. In this case, the operative connections can be lines through which fluids or electrical energy can be conducted, or also mechanical couplings such as shafts and the like.

If engine accessories are arranged outside a bypass channel, the operative connections extend through struts or aerodynamic profiles which radially pass through the bypass channel. However, the struts and the aerodynamic profiles reduce the flow cross section of the bypass channel and affect an airflow which is conducted through the bypass channel. In this case, the cross sections of the struts and the aerodynamic profiles are to be made larger, the more operative connections are to be guided through the bypass channel.

Furthermore, the reduction of the flow cross section of the bypass channel as a result of the cross sections of the struts and of the aerodynamic profiles requires the dimensions of the gas turbine engine to be increased. This is because the outside diameter of the bypass channel is to be designed to be correspondingly larger in order to be able to produce a required flow cross section of the bypass channel. However, an increase in the dimensions is undesirable, since drag of a gas turbine engine increases as the radial dimensions of an engine nacelle increase. The resulting fuel consumption impairs the range of an aircraft configured with a gas turbine engine and the payload thereof. A greater diameter of an engine nacelle also increases the total weight of a gas turbine engine, since a greater nacelle diameter requires a simultaneous increase in the nacelle length due to aerodynamics.

Moreover, it can be provided that, by means of the aircraft accessory gearbox, what are known as aircraft accessories are substantially operatively connected to the drive train. The aircraft accessories are provided to carry out functions of an aircraft which is configured with the gas turbine engine according to the present disclosure. The aircraft accessories can be arranged radially outside the bypass channel.

As a result, in a simple manner, it is possible to design an inside diameter of the bypass channel to be smaller by comparison with solutions in which aircraft accessories are also or exclusively arranged radially inside the bypass channel. Moreover, the aircraft accessories can be arranged radially outside the bypass channel in regions of the gas turbine engine in which an operating temperature of the gas turbine engine is lower than in regions which are located radially inside the bypass channel and thus closer to the engine core.

Furthermore, operative connections between aircraft accessories and devices of an aircraft do not have to be guided through the bypass channel when these are arranged radially outside the bypass channel. As a result, the required flow cross section of the bypass channel can be made available with a correspondingly small outside diameter of the gas turbine engine. Furthermore, the airflow through the bypass channel is also impaired to a limited extent, since the strut cross sections and the cross sections of the aerodynamic profiles can be provided to be correspondingly small. This leads to a low level of flow drag of a gas turbine engine, which has a positive effect on fuel consumption.

In addition, the above-described arrangement of the engine accessories and the aircraft accessories make it possible to continue to operate a gas turbine engine even in the event of a failure of the aircraft accessory gearbox. As a result, the availability of a gas turbine engine is improved in a simple manner.

The core accessory gearbox can be arranged at such a distance in relation to a central axis or axis of rotation of the gas turbine engine that oil return lines and sealing air lines can be designed without U-shaped curved portions. This is advantageous since, in such regions, preferably water and other material collects or settles.

Furthermore, a gas turbine engine can thus also have a simple construction because the engine accessories and the devices of a gas turbine engine which interact with the engine accessories can be positioned close to one another spatially.

Arranging the aircraft accessory gearbox and the aircraft accessories operatively connected thereto radially outside the bypass channel provides the additional advantage that the gas turbine engine according to the present invention can be used in various aircraft designs at low cost and without having to make complex design changes for this purpose. This is because only accessories which are each provided to supply the functions of an aircraft are to be adapted to the various aircraft designs. This adaptation has no effect on the basic construction of the gas turbine engine itself which is provided for the operation of the gas turbine engine. Since a gas turbine engine according to the present disclosure can be combined with various aircraft at low cost, advantages in terms of cost can be achieved in a simple manner.

Furthermore, an inside diameter of the bypass channel can be increased by comparison with known gas turbine engine solutions in order to be able to arrange substantially all the engine accessories required for the operation of a gas turbine engine radially inside the bypass channel. In turn, this measure reduces the installation space requirements outside the bypass channel and thus the installation space requirements radially inside an engine nacelle for the other accessories, since substantially only aircraft accessories are then to be arranged in this region.

So as not to limit the flow cross section of the bypass channel as a result of the increase in the inside diameter thereof, the outside diameter of the bypass channel can be increased. Since both the inside diameter and the outside diameter of the bypass channel are then greater, the height of the bypass channel is then smaller by comparison with a height of a bypass channel having a smaller inside diameter and a smaller outside diameter. The smaller height of the bypass channel in conjunction with the smaller installation space requirements outside the bypass channel makes it possible to make the total diameter of a gas turbine engine smaller, as a result of which the length of a gas turbine engine is also reduced in comparison with known solutions. This ultimately leads to a reduced level of flow drag of a gas turbine engine, which has a positive effect on fuel consumption.

In addition, it can be provided that the core accessory gearbox and the aircraft accessory gearbox overlap with the drive train at least in connecting regions in the circumferential direction of the gas turbine engine. A connection, which has the desired advantages in terms of installation space, of the two accessory gearboxes to the drive train and to the radial shaft respectively is then possible. Moreover, the core accessory gearbox and the aircraft accessory gearbox as well as accessories operatively connected thereto can then be arranged in each case in installation spaces which are provided radially inside the bypass channel and radially outside the bypass channel.

The gas turbine engine according to the present disclosure can then be designed so as to be advantageous in terms of installation space when the aircraft accessory gearbox is arranged in the circumferential direction at least in part in a region of the gas turbine engine in which the gas turbine engine comprises means which are designed to connect the gas turbine engine to an aircraft. In this case, it can be provided that the region of the gas turbine engine overlaps a fuselage of the aircraft when the engine is installed on the aircraft.

The core accessory gearbox and the aircraft accessory gearbox can also be arranged relative to one another in the circumferential direction according to further criteria. These criteria can be for example the accessibility of radially inner regions of a gas turbine engine, the possibility of transverse impacts of debris between gas turbine engines which are each arranged on opposite sides of an aircraft, and maintenance requirements. These constraints may require for example an arrangement in which only the parts of the two accessory gearboxes in which the accessory gearboxes are operatively connected to the drive train by means of the angle drives overlap in the circumferential direction.

In the case of another embodiment of the gas turbine engine according to the present disclosure, the core accessory gearbox is designed to transmit a torque and to drive an oil pump, a fuel pump, an air/oil separator and/or a permanent magnet alternator. In particular, the spatial proximity of the engine accessories which are provided for supplying fuel and oil to the gas turbine engine allows an optimized integrated solution. In this case, the oil pump is provided to supply the gas turbine engine with oil, for example to lubricate or cool various regions or components of the gas turbine engine.

The aircraft accessory gearbox can be designed to transmit a torque and to drive a pneumatic air-turbine starter, a hydraulic pump and/or an alternator. By means of the hydraulic pump, hydraulic fluid can be applied for example to hydraulic systems of an aircraft. In turn, it is then ensured in a simple manner that operative connections between such accessories and regions of an aircraft which are driven or supplied by these accessories are not to be guided through the bypass channel. This is advantageous in particular in the case of a pneumatic air-turbine starter, since a compressed air line provided for the operation of the air-turbine starter, depending on the design thereof, has a large diameter, for example of approximately 100 mm to 120 mm.

In addition, it can also be provided that the aircraft accessory gearbox is designed to transmit a torque and to drive an electric machine. The electric machine can be arranged in the radial direction of the gas turbine engine outside the bypass channel, that is to say on a side of the bypass channel facing away from the engine core, and designed, during motor operation, to start the gas turbine engine and, during alternator operation, to generate electrical energy. Then for example only electrical lines are to be guided through the bypass channel radially inwards towards the engine core in order to be able to supply devices of the gas turbine engine with electrical energy.

Furthermore, by means of the electric machine arranged radially outside the bypass channel, an aircraft can be supplied with electrical energy during alternator operation. In this case, the engine accessories can also be supplied with electrical energy by a permanent magnet alternator (PMA) which is driven by the core accessory gearbox.

If an electrically operable hydraulic pump is connected to the electric machine radially outside the bypass channel, and if the hydraulic pump can receive electrical energy from the electric machine, the gas turbine engine in turn can be designed to be advantageous in terms of installation space. This is because electrical lines having substantially higher degrees of freedom than mechanical couplings, such as shafts and the like, can be laid. In this case, the hydraulic pump can supply hydraulic systems of an aircraft with hydraulic fluid and can be arranged radially outside the bypass channel, that is to say radially outside the outside diameter of the bypass channel.

In turn, the higher degrees of freedom make it possible to arrange the electrically operable hydraulic pump in regions of the gas turbine engine, according to the present disclosure, outside the bypass channel, which regions have a corresponding installation space.

The core accessory gearbox can be arranged between the engine core and the bypass channel in the axial direction in the region of a rear side of a front engine frame. Since the associated fuel and oil system, such as an oil tank, a fuel-cooled oil cooler, a fuel control unit and the like, is conventionally likewise installed in this region of a gas turbine engine, as a result of the spatial proximity which is then present, a simplified installation and a connection of the engine accessories to the core accessory gearbox which is advantageous in terms of installation space are then possible.

Moreover, the core accessory gearbox can be supplied with cooling and lubricating oil by means of an oil system of the gas turbine engine in so far as necessary.

In the case of another advantageous embodiment of the gas turbine engine according to the present disclosure, the aircraft accessory gearbox can comprise a separate oil system. The separate oil system can be designed to supply the aircraft accessory gearbox and the accessories operatively connected thereto with oil. The availability of a gas turbine engine is thereby improved in a simple manner. This is because, in the event of a fault in the aircraft accessory gearbox, the gas turbine can then continue to operate without running the risk of losing all the oil.

Moreover, it is also possible to carry out function tests of a gas turbine engine without the aircraft accessory gearbox. This is advantageous in particular when the aircraft accessory gearbox is installed in the fuselage.

Separating the oil systems also provides the advantage that no impurities are exchanged between the oil systems of the gas turbine engine and of the aircraft accessory gearbox.

According to another aspect, an aircraft comprising at least one gas turbine engine as described in greater detail above is provided. The gas turbine engine can be arranged on the fuselage or in the fuselage of the aircraft. The aircraft accessory gearbox and the aircraft accessories operatively connected thereto are arranged radially outside the bypass channel in a region of overlap between the gas turbine engine and the fuselage. The aircraft accessories and the aircraft accessory gearbox can thus be arranged outside the bypass channel in such a way that the gas turbine engine itself can be designed with the smallest possible external dimensions.

In this case, it can be provided that the aircraft accessory gearbox and the aircraft accessories which are operatively connected thereto are arranged radially in the engine nacelle, in part radially in the engine nacelle and in part radially outside the engine nacelle, for example in a pylon and/or the fuselage, or radially outside the engine nacelle in the pylon and/or in the fuselage.

Furthermore, it is also possible to arrange the aircraft accessory gearbox in a region between the engine nacelle and the fuselage of an aircraft which is delimited by the engine nacelle, the fuselage and an aerodynamic casing. By means of an aerodynamic casing of this type, a transition between the engine nacelle and the fuselage of an aircraft which is optimized in terms of flow is provided.

In particular, arranging the aircraft accessories and the aircraft accessory gearbox radially outside the engine nacelle makes it possible to design the gas turbine engine according to the present disclosure with the smallest possible diameters and to reduce the drag of the gas turbine engine to a minimum.

If the electric machine is arranged so as to be radially aligned with the shaft of the drive train in the engine nacelle, in the pylon and/or in the fuselage, an outside diameter of the gas turbine engine in turn can be designed to be as small as possible.

In the case of another embodiment of the aircraft according to the present disclosure, in each case one gas turbine engine is provided at least on both sides of the fuselage.

The aircraft accessory gearbox and the core accessory gearbox can each be arranged in the circumferential direction of the gas turbine engine in such a way that the core accessory gearbox and engine accessories operatively connected thereto are shielded against damage from components by the aircraft accessory gearbox and the aircraft accessories operatively connected thereto. By way of example, in the event of damage, such components can escape with correspondingly high kinetic energy from one gas turbine engine, which is arranged on the opposite side of the fuselage, towards the other gas turbine engine. Damage to the core accessory gearbox and the engine accessories operatively connected thereto can then be prevented in a simple manner, and the availability of the gas turbine engine can be improved to a desired extent.

It is self-evident to a person skilled in the art that a feature or parameter described in relation to one of the above aspects can be applied to any other aspect, unless they are mutually exclusive. Furthermore, any feature or any parameter described here may be applied to any aspect and/or combined with any other feature or parameter described, unless they are mutually exclusive. Further advantages and advantageous developments of the invention can be found in the claims and the exemplary embodiments described based on the concept with reference to the drawings, in which:

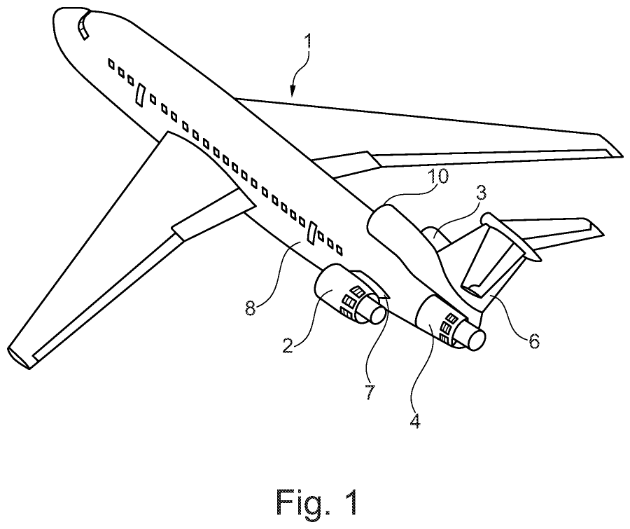

FIG. 1 is a simplified three-dimensional view of an aircraft with gas turbine engines arranged in the rear region on an aircraft fuselage;

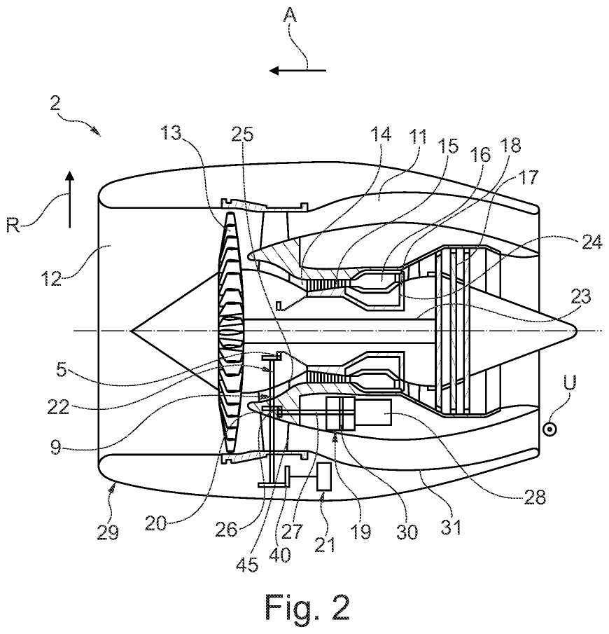

FIG. 2 is a simplified longitudinal sectional view of a gas turbine engine of the aircraft according to FIG. 1;

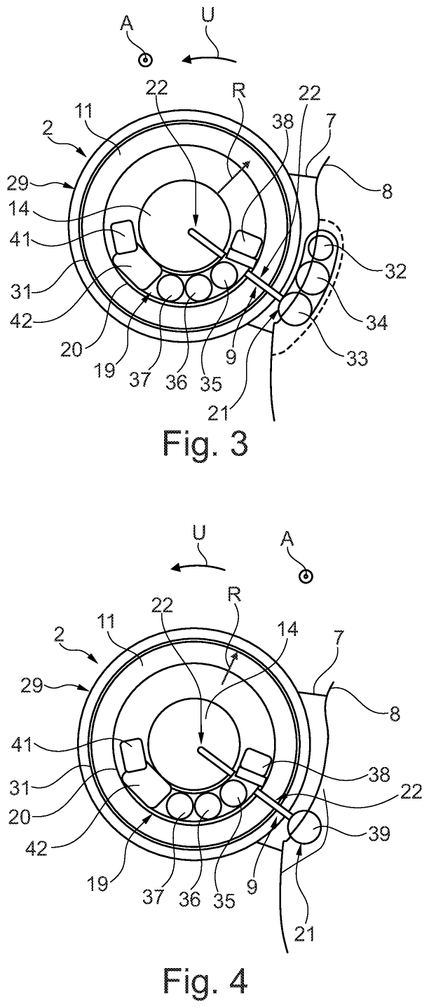

FIG. 3 is a simplified cross-sectional view of the gas turbine engine according to FIG. 2; and

FIG. 4 is an illustration corresponding to that of FIG. 3 of another embodiment of the gas turbine engine according to FIG. 2.

FIG. 1 shows an aircraft or a passenger aircraft 1 which has three gas turbine engines 2, 3, 4. The first gas turbine engine 2 is arranged on a left-hand side of the aircraft in the rear region of the aircraft 1, in the region of a vertical stabilizer 6, and is attached in the region of an engine pylon 7 to a fuselage 8 of the aircraft 1. The second gas turbine engine 3 is connected to the fuselage 8 substantially mirror-symmetrically on a right-hand side of the aircraft.

The third gas turbine engine 4 is positioned at the rear end of the fuselage 8 and is attached to an inner fuselage strut, which is arranged below the vertical stabilizer 6 of the aircraft 1. An air inlet 10 is provided to supply air to the third gas turbine engine 4. The air inlet 10 is arranged, in front of the vertical stabilizer 6 in a direction of flight, on a top side of the fuselage 8 and is connected, within the aircraft fuselage 8, to the third gas turbine engine 4.

FIG. 2 shows the gas turbine engine 2 of the aircraft 1 according to FIG. 1 in a simplified longitudinal sectional view. The gas turbine engine 2 comprises a subsidiary flow channel or bypass channel 11 and an inlet region 12. Downstream of the inlet region 12, a blower 13 is connected in a manner which is known per se.

After the blower 13, the fluid flow in the gas turbine engine 2 is divided into a bypass flow and a core flow. The bypass flow flows through the bypass channel 11, whereas the core flow flows into an engine core 14. The engine core 14 is configured with a compressor device 15, with a burner 16, with a low-pressure turbine 17 which is provided to drive the blower 13, and with a high-pressure turbine 18 provided to drive the compressor device 15.

In addition, FIG. 2 is a schematic view of a core accessory gearbox 19 which is arranged substantially in the region of an intermediate casing 20 of the gas turbine engine 2. The intermediate casing 20 is located in the radial direction R of the gas turbine engine 2 in a region between the engine core 14 and the bypass channel 11. Furthermore, an aircraft accessory gearbox 21 is arranged radially outside the bypass channel 11. The core accessory gearbox 19 and the aircraft accessory gearbox 21 are driven by a radial shaft 22 of a drive train 9 which is operatively connected to a core shaft 24 of the gas turbine engine 2 which core shaft extends in the axial direction A of the gas turbine engine 2. The radial shaft 22 is connected to the core shaft 24 by means of an angle drive 5. In the present case, the core shaft 24 is a high-pressure shaft of the gas turbine engine 2 which, in the operation of the gas turbine engine 2, rotates at a higher speed than another core shaft 23 arranged coaxially therewith which is what is known as a low-pressure shaft.

Starting from the core shaft 24, the radial shaft 22 extends substantially in the radial direction R of the gas turbine engine 2 through what is known as an inner strut 25, that is to say a strut formed with a hollow profile or an aerodynamic profile formed with a hollow profile, outwards through the engine core 14 to the intermediate casing 20. In the region of the intermediate casing 20, the radial shaft 22 interacts with a drive shaft 27 by means of another angle drive 26 in the form of a bevel gear set.

By means of gear pairs 30 of the core accessory gearbox 19, which in the present case are in the form of spur-gear stages, the drive shaft 27 is connected to what are known as engine accessories 28. In the present case, the engine accessories 28 are an air/oil separator, an oil pump, a fuel pump, a permanent-magnet alternator and other accessories which are provided for the operation of the gas turbine engine 2. In addition, in the intermediate casing 20, an oil tank and an oil cooler which can be temperature-controlled by fuel are also arranged radially inside the bypass channel 11 in the gas turbine engine 2.

The aircraft accessory gearbox 21 is arranged radially in an engine nacelle 29 which is delimited radially outwardly by an outer face of the engine nacelle 29 and radially inwardly by an outer face 31 of the bypass channel 11. An additional angle drive 40 is provided between the radial shaft 22 and the aircraft accessory gearbox 21. The radial shaft 22 extends through an outer strut 45, that is to say a strut formed with a hollow profile, or an aerodynamic profile formed with a hollow profile, through the bypass channel 11.

FIG. 3 is a simplified cross-sectional view of a first embodiment of the gas turbine engine 2 according to FIG. 2, in which the aircraft accessory gearbox 21 is arranged radially outside the engine nacelle 29 in the engine pylon 7. In the present case, a mechanically drivable hydraulic pump 32, a gas turbine engine starter 33 (air turbine starter, ATS) and an alternator 34 are what are known as aircraft accessories.

In the exemplary embodiment of the gas turbine engine 2 shown in FIG. 3, the core accessory gearbox 19 is arranged together with the engine accessories radially between the bypass channel 11 and the engine core 14. In the present case, the engine accessories are inter alia the previously mentioned fuel pump 35, the air/oil separator or a breather 36 and the oil pump 37. Furthermore, a fuel metering unit 38 (FMU), a measuring nozzle for controlling the amount of fuel which arrives at the burner 16, a fuel filter and an oil filter, an oil tank 41 and an oil cooler 42 which can be temperature controlled by means of fuel are also provided on the engine core 14 so as to be distributed in the circumferential direction U.

FIG. 4 shows a view corresponding to FIG. 3 of a second exemplary embodiment of the gas turbine engine 2 which differs from the design of the gas turbine engine 2 according to FIG. 3 only in some regions. The gas turbine engine 2 according to FIG. 4 comprises, instead of the gas turbine engine starter 33, what is known as an electric starter alternator 39, which, in the present case, is operatively connected to the radial shaft 22 by means of the aircraft accessory gearbox 21. The electric starter alternator 39 can be operated both as a motor and as an alternator so as to be able to start the gas turbine engine 2 and to generate electrical energy in the operation of the gas turbine engine 2. By means of the electrical energy of the starter alternator 39, for example an electric hydraulic pump and an on-board network of the aircraft 1 can be operated.

Both in the case of the gas turbine engine 2 according to FIG. 3 and in the case of the gas turbine engine 2 according to FIG. 4, the aircraft accessory gearbox 21, the aircraft accessories 32, 33 and 34, and the electric starter alternator 39 are arranged radially in part in the engine pylon 7 and in part in the fuselage 8.

### LIST OF REFERENCE SIGNS

1 Aircraft

2 to 4 Gas turbine engine

5 Angle drive

6 Vertical stabilizer

7 Engine pylon

8 Fuselage

9 Drive train

10 Air inlet

11 Bypass channel

12 Inlet region

13 Blower

14 Engine core

15 Compressor device

16 Burner

17 Low-pressure turbine

18 High-pressure turbine

19 Core accessory gearbox

20 Intermediate casing

21 Aircraft accessory gearbox

22 Radial shaft

23 Core shaft, low-pressure shaft

24 Core shaft, high-pressure shaft

25 Inner strut

26 Additional angle drive

27 Drive shaft

28 Engine accessory

29 Engine nacelle

30 Gear pair

31 Outer side of the bypass channel

32 Hydraulic pump

33 Gas turbine engine starter

34 Integrated alternator

35 Fuel pump

36 Air/oil separator

37 Oil pump

38 Fuel metering unit

39 Electric starter alternator, electric machine

40 Additional angle drive

41 Oil tank

42 Oil cooler

45 Outer strut

A Axial direction

R Radial direction of the gas turbine engine

U Circumferential direction

1. A gas turbine engine, comprising an engine core and comprising a bypass channel which radially surrounds the engine core at least in part,
wherein at least one core shaft extending in the axial direction is provided,
wherein the core shaft is operatively connected to a core accessory gearbox arranged between the engine core and the bypass channel and to an aircraft accessory gearbox by means of a drive train,
wherein the aircraft accessory gearbox is arranged radially outside the bypass channel,
wherein the drive train extends substantially in the radial direction between the core shaft and the aircraft accessory gearbox,
wherein the drive train has an angle drive between a radial shaft and the core shaft,
and wherein the drive train comprises another angle drive between the radial shaft and the core accessory gearbox and an additional angle drive between the radial shaft and the aircraft accessory gearbox.

2. The gas turbine engine according to claim 1, wherein the radial shaft is formed as a single piece.

3. The gas turbine engine according to claim 1, wherein the radial shaft has at least two radial shaft portions which are arranged coaxially with one another and one behind the other in the radial direction at least in some regions and are interconnected for conjoint rotation.

4. The gas turbine engine according to claim 1, wherein engine accessories are substantially operatively connected to the drive train by means of the core accessory gearbox, which engine accessories are provided to carry out functions of the gas turbine engine and are arranged between the engine core and the bypass channel.

5. The gas turbine engine according to claim 1, wherein aircraft accessories are substantially operatively connected to the drive train by means of the aircraft accessory gearbox, which aircraft accessories are provided to carry out functions of an aircraft which is configured with the gas turbine engine, the aircraft accessories being arranged radially outside the bypass channel.

6. The gas turbine engine according to claim 1, wherein the core accessory gearbox and the aircraft accessory gearbox overlap at least in regions of connection to the drive train in the circumferential direction of the gas turbine engine.

7. The gas turbine engine according to claim 1, wherein the aircraft accessory gearbox is arranged in the circumferential direction at least in part in a region of the gas turbine engine in which the gas turbine engine comprises means which are designed to connect the gas turbine engine to an aircraft, the region of the gas turbine engine overlapping a fuselage of the aircraft when the engine is installed on the aircraft.

8. The gas turbine engine according to claim 1, wherein the core accessory gearbox is designed to transmit a torque and to drive an oil pump, a fuel pump, an air/oil separator and/or a permanent magnet alternator.

9. The gas turbine engine according to claim 1, wherein the aircraft accessory gearbox is designed to transmit a torque and to drive a pneumatic air turbine starter, a hydraulic pump and/or an alternator.

10. The gas turbine engine according to claim 1, wherein the aircraft accessory gearbox is designed to transmit a torque and to drive an electric machine, the electric machine being arranged radially outside the bypass channel and designed, during motor operation, to start the gas turbine engine and to generate electrical energy during alternator operation.

11. The gas turbine engine according to claim 1, wherein an electrically operable hydraulic pump is connected to the electric machine radially outside the bypass channel and can receive electrical energy from this machine.

12. The gas turbine engine according to claim 1, wherein the core accessory gearbox is arranged in the axial direction in the region of a rear side of a front engine frame between the engine core and the bypass channel.

13. The gas turbine engine according to claim 1, wherein the aircraft accessory gearbox comprises a separate oil system which is designed to supply the aircraft accessory gearbox with oil.

14. An aircraft, comprising at least one gas turbine engine according to claim 1, wherein the gas turbine engine is arranged on the fuselage or in the fuselage of the aircraft, and wherein the aircraft accessory gearbox and the aircraft accessories which are operatively connected thereto are arranged radially outside the bypass channel in a region of overlap between the gas turbine engine and the fuselage.

15. The aircraft according to claim 14, wherein the aircraft accessory gearbox and the aircraft accessories which are operatively connected thereto are arranged radially in an engine nacelle, in part radially in the engine nacelle and in part radially outside the engine nacelle in an engine pylon and/or the fuselage or radially outside the engine nacelle in the engine pylon and/or in the fuselage.

16. The aircraft according to claim 14, wherein the electric machine is arranged so as to be radially aligned with the radial shaft in the engine nacelle, in the engine pylon and/or in the fuselage.

17. The aircraft according to claim 14, wherein in each case one gas turbine engine is provided at least on both sides of the fuselage, the aircraft accessory gearbox and the core accessory gearbox each being arranged in the circumferential direction of the gas turbine engines in such a way that the core accessory gearbox and engine accessories operatively connected thereto is shielded against components which, in the event of damage, escape from a gas turbine engine which is arranged on the opposite side of the fuselage with correspondingly high kinetic energy towards the other gas turbine engine by the aircraft accessory gearbox and aircraft accessories connected thereto.
